(19) United States
(12) Patent Application Publication
(10) Pub. No.: US 2012/0301776 A1
(43) Pub. Date: Nov. 29, 2012

(54) BATTERY CELL HAVING ANGLED CONTACT SECTION

(75) Inventors: Claus-Rupert Hohenthanner, Hanau (DE); Joerg Kaiser, Kamenz (DE); Andrea Gutsch, Luedinghausen (DE); Claudia Brasse, Hanau (DE); Tim Schaefer, Niedersachswerfen (DE)

(73) Assignee: LI-TEC BATTERY GMBH, Kamenz (DE)

(21) Appl. No.: 13/453,941

(22) Filed: Apr. 23, 2012

Related U.S. Application Data
(63) Continuation of application No. 13/255,483, now abandoned.

(30) Foreign Application Priority Data
Mar. 12, 2009 (DE) 10 2009 012 948.0

(51) Int. Cl. H01M 6/42; H01R 43/02; H01M 2/30

(52) U.S. Cl. 429/158; 429/179; 29/879

(57) ABSTRACT

Battery cell 1, in particular flat battery cell, comprising at least one packaging for receiving at least one electric cell, at least one conductor 3, which has at least one base section 4 and at least one contacting section 5, wherein said contacting section is bent relative to the base section 4.

The present invention relates to a battery cell, which, in particular, is designed as a flat battery cell. Such battery cells comprise a packaging in which at least one electrical cell was inserted. An electrical cell can be a primary battery cell, i.e. a non-rechargeable battery cell. The battery cell may also be a secondary battery cell, i.e. a rechargeable battery cell. A conductor (electrical conductor) is electrically conductive connected to electrodes of the electric cell. Such battery cells are used, particularly, in electrically powered vehicles.

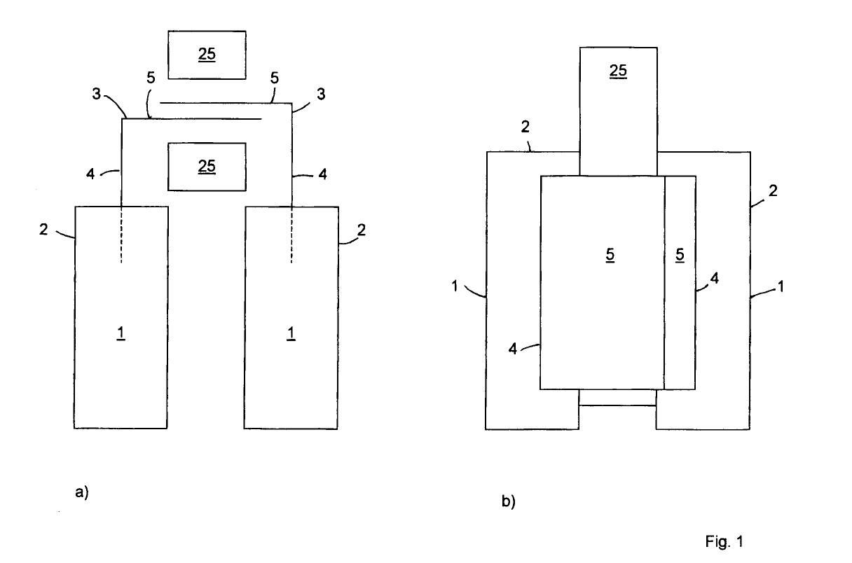

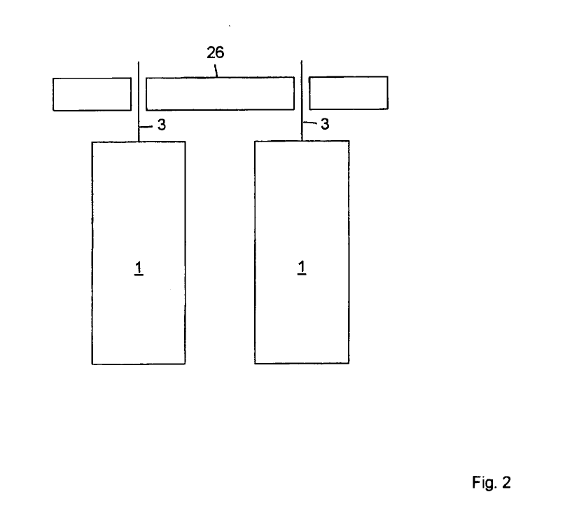

The state of the art is described based on FIGS. 1 and 2. FIG. 1 shows two battery cells 1, each having a conductor 3, which forms a connection of the battery cell 1 to the outside. A second conductor is not illustrated. The conductor 3 has a base section 4, which protrudes through the packaging 2 of the battery cell 1. Conductor 3 further has a contacting section 5, which can be brought in contact with a contacting section 5 of a second battery cell 1. The contacting sections 5 of two battery cells 1 can be welded together by means of a welding gun 25, whose two arms are illustrated. The lower arm of the welding gun 25 extends into a tubular space, which is formed by conductors 3 and packaging 2 of the two battery cells 1.

FIG. 2 shows another example of the state of the art. A battery cell 1 has a conductor 3, which extends evenly. An additional electrically conductive contacting element 26 is arranged in the space between the two contacting sections 5 for the electrical connection of the contacting sections 5 of two adjacent battery cells 1.

The objective of the present invention is to provide an improved battery cell.

The underlying objective of the invention is solved by a battery cell, in particular, by a flat battery cell, comprising at least one packaging for receiving at least one electric cell, at least one conductor, which has at least one base section and at least one contacting section, wherein the contacting section is bent relative to the base section.

The contacting section is preferably used to bring the conductor in electrical connection with an external component, in particular with a connecting element or with a connecting sleeve. In addition, a contacting section can also be brought in indirect or direct contact with a contacting section of an adjacent battery cell to establish an electrical connection between two battery cells. Therein, the base section of the conductor represents the area of the conductor by means of which the conductor protrudes through the packaging. By means of a bending between the base section and the contacting section, the contacting section can be brought into a favorable geometrical position for improved connectivity.

Preferably, the contacting section is bent relative to the base section in expect to a bending axis, wherein the bending axis is arranged parallel to a direction of the module of the battery cell. The direction of the module of a prismatic battery cell can be defined via the alignment directions of the longest outer edge of the battery cell. The direction of the module of a prismatic cell can also be defined by an axis that is vertical to one side surface area, wherein, as a reference surface area, preferably, the side surface area is used, through which the base section protrudes through the packaging. The direction of the module for a round battery cell may be defined by the longitudinal axis, relative to which the cylindrical outer surface area of the round battery cell extends in parallel. The direction of the module can also be defined by a vertical line through the section of the surface area of the packaging of the battery cell, which is protruded by the base section.

Since the contacting section is bent relative to the base section in respect to a bending axis, which extends in the direction of the module of the battery cell, a contacting surface area, which is arranged on the contacting section, is aligned in parallel to the direction of the module. A tool, which may be used to connect two contacting sections, may then be moved to the contacting section, in particular by a movement in the direction of the module, and thereby, has to travel only a short distance. A tool arm, which may carry the tool, may be designed having a short arm. Such a tool may be a welding gun. A tool arm may be the arm of a welding gun.

By means of such bending, the contacting section, which comprises the contacting surface area, may extend in the direction of an adjacent battery cell, which is arranged at a largest side surface area of the battery cell. In particular, when contacting sections of adjacent battery cells are directed towards each other, a contacting of the contacting section is simplified and may result, in particular, in material and weight reduction.

Preferably, the contacting section is bent relative to the base section in an approximately perpendiculary manner. The term “perpendicular” or “rectangular” is generally to be interpreted in a broad sense and comprises also, in particular, deviations from exactly 90° all the way to 15°. Preferably, the sum of the degree of bending for two adjoining contacting sections of adjacently arranged battery cells equals 180°. Thereby, it may be achieved that the contacting sections are aligned parallel to each other.

Preferably, a conductor has at least two contacting sections. The contacting sections may be designed to be identical.

Preferably, a conductor has, essentially, an L-shape, wherein, in particular, one arm is formed by the base section and one arm is formed by the contacting section. The arms are, in particular, formed in an elongated shape and are, preferably, arranged in a perpendicular manner to each other. The arms are, preferably, formed flat-shaped.

In another embodiment, the conductor may be designed in a U-shape, which is, preferably formed by the base section and contacting sections, which are arranged laterally thereon, on each side. The contacting sections are arranged, preferably, on opposite areas of the base section. Both contacting sections are bent relative to the base section, preferably, each in respect to a bending axis, wherein both bending axes are, preferably, arranged in parallel to each other.

Preferably, the contacting section extends away from the base section in a direction, which runs perpendicular to a largest surface side area of the battery cell. For prismatic battery cells or round cells, the largest surface side area may be the one, which has, the largest surface area in terms of modules.

In round cells, the direction of the module may be perpendicular to a base circle, which spans, preferably, a cylindrical boundary surface area of the battery cell. The direction of the module thereby extends, in parallel, in particular coaxial to the cylindrical surface area.

Preferably, a contacting section is arranged in parallel to the base section. This can be implemented, in particular, by multiple bendings in respect to, in particular, two bending axes of the conductor. The bending axes may be arranged in parallel to each other. The bending axes may be aligned perpendicular to the direction of the module. Preferably, the contacting section is arranged at a distance in respect to the base section. Between the base section and the contacting section, a connecting bridge may be provided. The base section and the contacting section may extend in the same direction, in respect to the connecting bridge. The bending between the connecting bridge and the base section may be implemented to be of the same direction as the bending between contacting section and connecting bridge. The conductor may, preferably, have a U-shape, wherein the outer arms of the U-shape may be formed by the base section and the contacting section. The base of the U-shape may be formed by the connecting bridge. The connecting bridge may be arranged perpendicular in respect to the base section and/or to the contacting section. Preferably, a contacting section is spaced away from the base section by at least a length, which at least corresponds to a distance of the base section to a side surface area of the battery cell, which runs in parallel to the base section. Thereby, the contacting section is shifted from the base section by at least such a distance, that the contacting section aligns with a side surface area of the battery cell, or, in particular extends beyond the side surface area. Thereby, the contacting section can easily be brought into contact, in particular, with contacting sections, of battery cells that are similarly designed and adjacently arranged, all this without the need of additional components, in particular, of space bridging connecting bridges. This allows, in total, to reduce the number of components and thus, the weight, as well as the total assembly effort.

A contacting section may, preferably, have a sawtooth structure. A sawtooth structure may provide the advantage, that several different connecting points are present, which are, in particular produced by welding joints. Furthermore, in particular, tension stresses on the battery cells, which may be noticeable, in particular, as shear stresses on the contacting section, are thereby at least partially directed into normal force components. Thereby, the durability of the connection of the contacting section will be increased. Moreover, the modules of a contacting area of a contacting section may be enlarged by using a sawtooth structure. In this respect, an enlarged contacting surface area can be provided for connecting adjacent battery cells.

Preferably, the base section has at least one through-hole. Means of traction may be guided through the through-holes, which allow a tensioning/fixing of the base sections and/or the battery cell with other components. Preferably, the base section has a first aligning means, in particular at least one, further particular two aligning-holes. The aligning means may serve to align other components, in particular insulating elements, relative to the conductor and/or the battery cell. The aligning means may also be used for an alignment of an assembly tool.

Preferably, at least one spacing element is arranged between the base section and the contacting section. The spacing element serves for maintaining a predetermined distance and/or for a predetermined alignment, in particular an angular alignment, between a base section and a contacting section.

A spacing element may therein transfer a force, which acts either on the base section or on the contacting section, to the respectively other of the two elements. The spacer may be made of an electrically insulating material. The spacer may be made of an electrically conductive material.

Preferably, a width of a spacing element corresponds to a length of a section of the bridge of the conductor. A section of the bridge of the conductor may be a connecting bridge between the base section and the contacting section. The spacing element may be arranged between the contacting section and the base section.

The underlying objective of the invention is further achieved by a battery assembly, comprising at least two of the aforementioned battery cells, wherein contacting sections of adjacent battery cells are electrically connected with each other, in particular directly connected with each other.

Side surface areas of adjacent battery cells may be directly adjacent to each other. A heat conductive plate may be arranged between the side surface areas of adjacent battery cells.

Preferably, contacting sections of adjacent battery cells are directly electrically connected with each other, in particular by means of welding, further particulary by ultrasonic welding. Ultrasonic welding allows simply and reliably to connect two contacting section.

Preferably, U-shaped conductors of adjacent battery cells together form a closed surface area, in particular a circularly closed circumferential surface area. Thereby, in particular, two contacting sections, respectively of a battery cell are always connected with a contacting section of an adjacent battery cell, hence in total with two contacting sections. By means of the closed surface area, in particular, a high area moment of inertia of the two conductors, which are connected with each other, is established. Said conductors therefore display high rigidity vis-à-vis externally applied forces.

Preferably, an insulating body is arranged between the base sections of adjacent battery cells, in particular between the base sections of conductors, and, in particular within a closed surface area. The insulation body may serve as a spacing element between the base sections of two adjacently arranged battery cells. Therein, the spacing element is, preferably, arranged such that it may absorb pressure forces, which are caused by attaching conductors to each other, so that the conductor sections are held in their respective position in the battery cell. This is, in particular, advantageous, when the conductors are pressed together by means of traction. By fixing the conductor in its position relative to the battery cell, mechanical stresses on the conductor are avoided, in particular, on the connection to the battery cell or in the area, in which the conductor protrudes through the packaging of the battery cell. The insulating body can further be used for insulating the conductors of adjacent battery cells. This is advantageous, in particular, when the insulating body is arranged between two conductors, which are meant to not interfere with each other, by means of an electrically conductive connection. In case the insulation body is arranged between two electrically connectable conductors, the insulation material may also be made of electrically conductive material. In this case, the insulation body serves, in particular, as a mechanical spacing element, without acting as an electrical insulator.

In one battery assembly, similar insulating bodies may be used both as mechanical spacing elements, as well as electrical insulating elements. This leads to a reduction in the number of parts.

Preferably, the insulating body has a second through-hole. Preferably, a means of traction, which may press together the conductors and the insulation bodies, may be guided through the second through-hole. The second through-holes of the insulating bodies may have the same diameter as the first through-holes of the conductors.

Preferably, an insulating body has second aligning means, in particular in form of at least one aligning protrusion, in particular two aligning protrusions. Thereby, a first aligning means of battery cells, in particular of conductors of battery cells, may be brought in engagement with a second aligning means of the insulating bodies. In particular, one or several, in particular two, aligning protrusions of one or several insulation bodies may engage in one or several, in particular in two, aligning-holes of the battery cells, in particular, of the conductor.

Preferably, an anchor rod is guided through through-holes. The through-holes may be arranged in the insulating body and/or in the battery cell, in particular, in the conductors of the battery cell. This allows the pressing together of the aforementioned components.

The objective of the invention is further achieved by a method of producing an aforementioned battery assembly, comprising the following steps: contacting a side surface area of a battery cell with a side surface area of an adjacent battery cell, connecting a contacting section of a battery cell with a contacting section of an adjacent battery cell, in particular by material engagement. Preferably, the connection of the contacting section is established by joining by material engagement, in particular by welding, in particular by ultrasonic welding. The side surface areas of the battery cells do not necessarily have to touch each other. A heat conductive plate can be arranged between the side surface areas.

Preferably, at least one insulating body is arranged between the conductors of adjacent battery cells, in particular an insulating strip.

The insulating bodies and the base sections may be aligned along a joint aligning axis. The joint aligning axis may thereby, be defined by coaxially arranged through-holes on both the base section as well as on the insulating bodies. Means of traction, in particular an anchor rod, may be guided through the aligning-holes, with which the insulating bodies and the conductors may be pressed together.

Preferably, the insulating bodies are aligned relative to the conductors, in particular first aligning means of the conductor are brought in engagement with second aligning means of the insulating body. Thereby, preferably, aligning protrusions of the insulating body may be inserted into aligning-holes of the conductor.

Preferably, the battery cells are pressed against each other by means of traction, in particular by an anchor rod. Thereby, preferably, an anchor rod may be guided through a first through-hole of the conductor, in particular in a through-hole of a base section of the conductor, and a second through-hole of the insulating body.

Preferably, a tool component, in particular at least one arm of a welding gun, may be moved along a direction of a module towards the contacting section.

The invention is further illustrated by the following figures. These show:

FIG. 1 shows the contacting of two battery cells according to prior art
a) in side view
b) in a plan view;

FIG. 2 shows, in a side view, the alternative contacting of two battery cells according to prior art;

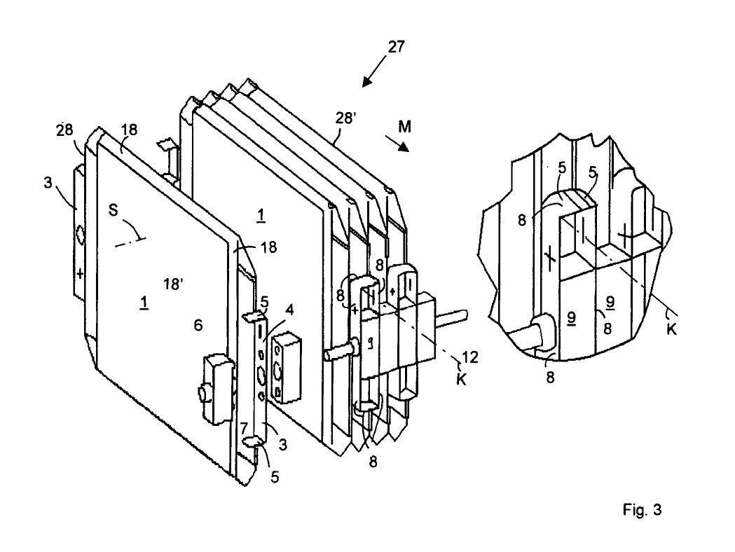

FIG. 3 shows in a perspective view, a battery assembly according to the invention with a plurality of battery cells according to the invention,

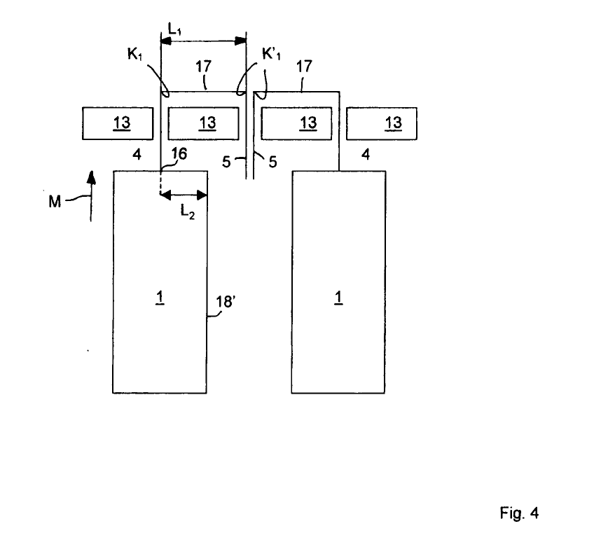

FIG. 4 shows two adjacent battery cells according to the invention in a battery assembly according to the invention;

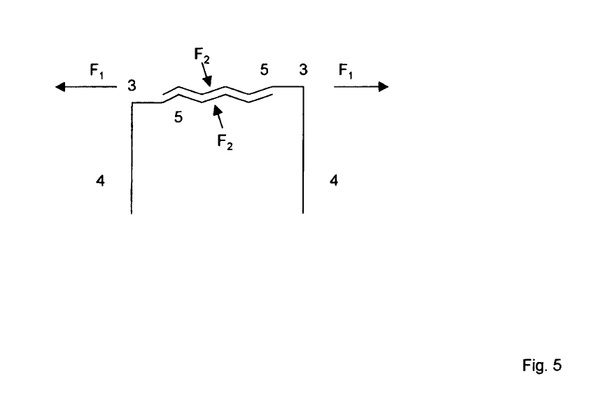

FIG. 5 shows contacting sections with a sawtooth structure;

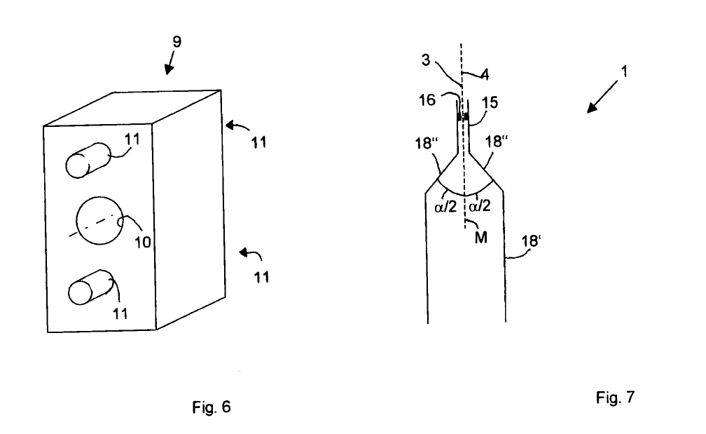

FIG. 6 shows an insulating body of the battery assembly;

FIG. 7 shows the sealing area of a battery cell.

FIG. 3 shows five battery cells 1, which together are part of a battery assembly 27. The battery cells 1 are designed as flat battery cells and have several side surface areas 18. The side surface area 18′ has the largest modulus surface area of all side surface areas 18. Battery cells 1 are directly in contact with each other along their largest side surface areas 18′. Alternatively, a heat conductive plate, which is not illustrated, may be arranged in between the side surface area 18′. All side surface areas 18 of a battery cell 1 form the packaging 2 of the battery cell 1.

Each battery cell 1 has two conductors 3, which protrude through the packaging 2 of the battery cell 1. The area of the conductor 3, along which the conductor 3 protrudes through the packaging 2 is the base section 4 of conductor 3. Base section 4 thereby protrudes, the packaging along a sealed area of the packaging. Thereby, an annular space, which is formed between the base section 4 and the packaging 2 is sealed by sealing means, which are not illustrated.

The battery cell 1 has several boundary edges 28. A longest boundary edge 28′ is designed to be straight and defines a direction of a module M. The base section 4 of the conductor 3 is essentially aligned in parallel to the direction of the module M. Each of the conductors 3 has two contacting sections 5, which are arranged on the base section 4 of the conductor 3. The contacting sections 5 are arranged on opposite areas of the base section 4. Contacting sections 5 are bent to be perpendicular, relative to the base section 4, namely in respect to a bending axis K, which is aligned in parallel to the direction of the module M. Contacting sections 5 extend in the direction of adjacent battery cells, and, in particular towards the contacting sections 5 of adjacent battery cells 1. Contacting section 5 is aligned in parallel to a vertical axis S and to a largest side surface area 18′. Contacting areas on the contacting sections 5 of adjacent battery cells 1 thus are in direct contact with each other, when the battery cells 1 are accommodated in a final alignment with each other. When assembled, the contacting sections of adjacent battery cells are therefore in contact with each other. Other connecting spacer elements for connecting the contacting sections 5 are not necessarily required.

As can be seen, in particular from the enlarged sectional view of FIG. 3, contacting sections 5 of adjacent battery cells are adjacent to each other and thereby, establish the electrical connection between two adjacent battery cells 1. Contacting sections 5 and base sections 4 of two interconnected conductors 3 of adjacent battery cells 1 thereby form, a circularly closed circumferential surface area 8, in which an insulating body 9 is arranged. The insulating body 9 may take up, in particular, pressure forces between the two base sections 4. An insulating body 9 is also arranged between base sections 4 of conductors 3 of adjacent cells, which are not interconnected with each other. In addition to taking up mechanical forces, this insulating body, may also form an electrical insulation between the respective conductors. Insulating bodies 9 have second through-holes 10. When assembled, the first through-holes 6 and the second through-holes 10 align in respect to a mutual axis, wherein an anchor rod 12 is guided through both through-holes 6, 10. The anchor rod 12 may press the assembly of battery cells 1 and insulating body 9 together by means of tensioning. The insulating bodies 9 form a support, which may absorb pressure forces, so that the conductors 3 are not mechanically stressed with respect to the battery cell body. The insulating bodies 9 thereby, as act as spacing elements.

FIG. 4 shows battery cells 1 of a battery assembly in an alternative example. Battery cells 1 each have a conductor 3, which has a base section 4, a connecting bridge 17, as well as a contacting section 5. The connecting bridge 17 is bent relative to the base section 4 by a bending axis K₁ of 90°. The contacting section 5 is bent relative to the connecting bridge 17 by a bending axis K₁, wherein the bending axis K₁′ is in parallel to the bending axis K₁. The bending axes K₁, K₁′ are perpendicular to the direction of the module M. In this respect, the conductor 3 is subject to multiple bending. Contacting section 5 is arranged in a distance to the base section 4, wherein the distance L₁ to the base section is larger than a distance L₂, which corresponds to the distance from the base section to a side surface area 18′, which runs parallel to the base section. The contacting section extends beyond the side surface area 18′ of the battery cell 1 and may therefore, directly come in contact with the contacting section of the adjacent battery cell 1. A spacing element 13 is arranged between the contacting section and the base section. Said spacing element may absorb pressure forces and thus, may prevent an interference of the contacting section on the base section and vice versa. A base section is enclosed by spacing elements 13 from two sides. Base section 4 is designed flat-shaped and protrudes in a flat-shaped manner from the inside of the packaging of the battery cell 1, all the way behind the spacing elements 13. Stresses in the critical sealing area 16, i.e. in the area in which the base section 4 protrudes the packaging, are avoided by means of the base section 4 being designed flat-shaped all the way beyond the spacing elements 13. Only in an area behind the spacing elements 13, the first bending of the conductor is implemented. Outside the packaging 2, the base section 4 has expands in the direction of the module, said expansion corresponds at least to an expansion of the corresponding spacing element in the direction of the module. The connecting bridge 17 thereby bridges a distance up to the contacting section of the adjacent battery cell 1.

FIG. 5 shows conductors 3 of adjacent battery cells 1, which are not further illustrated, wherein the contacting sections 5 are brought into contact with each other. Contacting sections 5 have a sawtooth structure. By means of the sawtooth structure, the effective contacting surface area between two contacting sections is increased, while maintaining the same distance. Pulling forces F₁, which pull the contacting section 5 away from each other, have, in the case of contacting surface areas with sawtooth structure, the effect, that they have normal force components F2 directed perpendicular to the contacting surface area 5. Hence, shear stress that may arise in case of flat-shaped contacting sections, may be converted to normal force components. Thereby, the connection of the contacting sections becomes more robust.

FIG. 6 shows the insulating body 9 according to the assembly of FIG. 3 in detail. The insulating body 9 is designed as an insulating strip and has a rectangular shape. A second through-hole 10 is provided, which extends perpendicular to a boundary edge of the insulating body 9. Furthermore, insulating body 9 has two aligning protrusions 11, which are arranged on opposite sides of the second through-hole 10. Furthermore, insulating body 9 has two additional aligning protrusions 11, which are arranged on the non-visible back side of the insulating body 9.

FIG. 7 shows a sectional view of a battery cell as used in FIG. 3. Here, a section of the, by area, largest surface area can be seen, as well as, with dashed lines, conductor 4, which extends with its base section 4 through the packaging of the battery cell 1. A second side surface area is formed by two inclined side surfaces areas 18″. Between the side surface areas 18″, a circumferential mounting flange 15 extends, through which the base section 4 of the conductor 3 protrudes through, as illustrated in the sectional view. Sealants 16 are provided in area with ring-shape, which is formed by the mounting flange 15 and the base section 4. Said sealants seal the opening through which the base section 4 protrudes through the packaging. The direction of the module M, as illustrated, can, in addition to the above-mentioned possibilities, also result from a bisecting line of the two side surface areas 18″, which together form the side surface areas from which the base section 4 extends.

### LIST OF REFERENCES

1 battery cell
2 packaging
3 conductor
4 base section
5 contacting section
6 first through-hole
7 aligning-hole
8 circularly closed circumferential surface area
9 insulating body
10 second through-hole
11 aligning protrusion
12 anchor rod
13 spacing element
15 mounting flange
16 sealant
17 connecting bridge
18 side surface area
19 welding gun
26 contacting element
27 battery assembly
28 boundary edge
K bending axis
M direction of the module
L distance (length)
B width
S vertical

1-32. (canceled)

33. A battery assembly comprising
a first battery cell (1), and
a second battery cell (1), each of the two battery cells comprising
at least a packaging (2) for receiving at least one electric cell,
at least a conductor (3), which has at least one base section (4) and at least one contacting section (5), wherein said contacting section (5) is bent relative to the base section (4).
at least one U-shaped conductor (3), with a base section (4), a contacting section (5) and a connecting bridge, which is arranged between the base section (4) and the contacting section (5) wherein
the outer arms of the U-shape are formed by the contacting section (5) and by the base section (4), and the base of the U-shape is formed by the connecting bridge, and
the contacting section (5) of the first battery cell (1) is electrically connected to the contacting section (5) of the second battery cell (1).

34. The battery assembly according to claim 33, wherein the base section (4), of the first battery cell (1) and/or the base section (4), of the second battery cell (1) has a first aligning means, in particular at least one, in particular two aligning-holes (7).

35. The battery assembly according to claim 34 comprising a spacer (13), which is arranged between the base section (4) and the contacting section (5) of the first battery cell (1).

36. The battery assembly according to claim 35, wherein the width (B) of the spacer (13) corresponds to a length (L) of a section of the bridge of the first battery cell (1).

37. The battery assembly according to claim 36, wherein the spacer (13) has two aligning means, in particular at least one aligning protrusion (11).

38. The battery assembly according to claim 37, wherein the first aligning means (7) are engaged with the second aligning means (11).

39. A battery cell (1), comprising
at least one packaging (2) for receiving at least one electric cell,
at least one conductor (3), which has at least one base section (4) and at least one contacting section (5), wherein
said contacting section (5) has a sawtooth structure and is bent relative to the base section (4).

40. A battery assembly with
a first battery cell according to claim 7, and
a second battery cell according to claim 7, wherein
the contacting section (5) of the first battery cell (1) is electrically connected to the contacting section (5) of the second battery cell (1).

41. The battery assembly according to claim 40, wherein the first battery cell (1) is adjacently arranged to the second battery cell.

42. The battery assembly according to claim 41, wherein the contacting section (5) of the first battery cell (1) is directly, electrically-connected with the contacting section (5) of the second battery cell (1).

43. The battery assembly according to claim 42, wherein the contacting section (5) of the first battery cell (1) is directly, electrically-connected by ultrasonic welding to the contacting section (5) of the second battery cell (1).

44. A method for the manufacture of a battery assembly according to claim 33, comprising the following steps:
contacting a side surface area (18) of a battery cell (1) with a side surface area (18) of an adjacent battery cell (1), and
connecting a contacting section (5) of a battery cell (1) with a contacting section (5) of an adjacent battery cell (1), wherein
the battery cell (1) and the adjacent battery cell (1) have a U-shaped conductor (3) with a base section (4), a respective contacting section (5) and a connecting bridge, which is arranged between the base section (4) and the contacting section (5),
and wherein
the outer arms of the U-shape are formed by the contacting section (5) and the base section (4), and the base of the U-shape is formed by the connecting bridge.

45. A method for the manufacture of a battery assembly according to claim 33, comprising the following steps:
contacting a side surface area (18) of a battery cell (1) with a side surface area (18) of an adjacent battery cell (1), and
connecting a contacting section (5) of a battery cell (1) with a contacting section (5) of an adjacent battery cell (1), wherein
the battery cell (1) and the adjacent battery cell (1) have a conductor (3) with a base section (4) and a respective contacting section (5), and wherein
said contacting section (5) has a sawtooth structure and is bent relative to the respective base section (4).

46. The method according to claim 45, wherein connecting the contacting sections (5) is implemented by material engagement, in particular by ultrasonic welding.
